(19) United States
(12) Patent Application Publication
(10) Pub. No.: US 2020/0045932 A1
(43) Pub. Date: Feb. 13, 2020

(54) SYSTEMS AND METHODS FOR IDENTIFYING AND LOCATING AN ANIMAL HAVING ATTACHED THERETO A RADIO FREQUENCY IDENTIFICATION TAG

(71) Applicant: Somark Innovations Group Pty Ltd, Sydney, NSW (AU)

(72) Inventors: Adrian KNIGHT, Sydney, NSW (AU); Paul DONOHOE, Sydney, NSW (AU)

(21) Appl. No.: 16/077,728

(22) PCT Filed: Feb. 11, 2017
(86) PCT No.: PCT/AU2017/050116

§ 371 Date: Aug. 13, 2018

Related U.S. Application Data
(60) Provisional application No. 62/294,084, filed on Feb. 11, 2016.
(60) Provisional application No. 62/414,147, filed on Oct. 28, 2016.

(51) Int. Cl. A01K 11/00; G06K 7/10; A01K 29/00; A01K 1/03; G06K 9/00; H04W 4/80; G01S 5/02; G01S 5/14

(52) U.S. Cl. CPC A01K 11/008; G06K 7/10386; A01K 29/005; G01S 5/14; G06K 9/00362; H04W 4/80; G01S 5/0221; A01K 1/03

(57) ABSTRACT

A system for locating a plurality of animals distributed between a plurality of enclosures. The plurality of animals have attached thereto a plurality of RFID tags for identifying each of the plurality of animals. The system comprises a plurality of RFID tag detection zones distributed between the plurality of enclosures. Each of the plurality of RFID tag detection zones have an RFID antenna for receiving a radio signal comprising animal identity information generated by any one of the plurality of RFID tags attached to the plurality of animals when interrogated. The RFID antenna of each RFID tag detection zone are in signal communication with at least one RFID reader for receiving the radio signal comprising animal identity information.

### TECHNICAL FIELD

The disclosure herein generally relates to systems and methods for locating and/or identifying at least one animal having attached thereto a radio frequency identification (RFID) tag.

### BACKGROUND

Animal husbandry, animal experimentation, and animal health monitoring, for example, may require at least one animal (in some instances thousands of animals) to be housed in at least one enclosure (in some instances thousands of enclosures).

Presently, a census of the at least one animal may generally require a manual count and/or manual survey of a plurality of animals in the at least one enclosure. The census may include manual observation of the plurality of animals to determine their condition and/or behaviour. In a research facility having a plurality of enclosures, the number of animals in each of the plurality of enclosures may be required. There may be thousands of enclosures in the research facility. The number of animals manually counted may then be recorded manually, for example on records in the form of enclosure cards attached to the plurality of enclosures. The identity of animals may also be manually obtained by inspecting ear identification notches or attached tags for checking that each of the plurality of animals is in the correct enclosure of the plurality of enclosures.

Manual counting, manual surveys and manual observation may be performed remotely using electronic video or infrared imaging surveillance. The images produced by electronic video or infrared imaging surveillance may be analysed manually or by relatively expensive and complex computer analysis. This may not remove the need for human observation however.

Manual counting, manual surveys and manual observation, even remotely, is relatively expensive and time consuming. It may not be possible to operate electronic video or infrared imaging surveillance during various phases within enclosures, for example during dark phases or cleaning phases. This may limit the quality and quantity of data that may be obtained, which may reduce the quality of research outcomes.

In the context of this specification, an animal may be generally any suitable non-human animal or human, including a laboratory animal, a rodent, a rat, a mouse, a cat, a dog, a rabbit, a bird including a poultry bird, livestock including cattle, sheep and horses, a zoo animal or generally any type of animal.

### SUMMARY

Disclosed herein is a system for locating a plurality of animals distributed between a plurality of enclosures. The plurality of animals has attached thereto a plurality of RFID tags for identifying each of the plurality of animals. The system comprises a plurality of RFID tag detection zones distributed between the plurality of enclosures. Each of the plurality of RFID tag detection zones have an RFID antenna for receiving a radio signal comprising animal identity information generated by any one of the plurality of RFID tags attached to the plurality of animals when interrogated. The RFID antenna of each of the plurality of RFID tag detection zones is in signal communication with at least one RFID reader for receiving the radio signal comprising animal identity information.

In an embodiment, the at least one RFID reader is in data communication with a processor and is configured to send the animal identify information and location information indicative of the RFID tag detection zone associated with the radio signal to the processor. The processor may be configured to generate census information indicative of the distribution of the plurality of animals between the plurality of enclosures. The census information may be indicative of the distribution of the plurality of animals between the plurality of enclosures and the location of each of the plurality of animals within the plurality of enclosures. The census information may be indicative of the behaviour and/or condition of the animals.

In an embodiment, more than one of the plurality of RFID tag detection zones are associated with each of the plurality of enclosures for determining animal location within each of the plurality of enclosures. Alternatively, one of the plurality of RFID tag detection zones are associated with each of the plurality of enclosures.

In an embodiment, the plurality of enclosures and the at least one RFID reader are received by a rack. The rack may be configured to receive the animal identify information and the location information. The rack may be configured to aggregate the animal identity information and location information associated with a plurality of radio signals. The rack may be configured to send the aggregated animal identity information and location information, for example to the processor. The rack may be configured to power the at least one RFID reader.

In an embodiment, the plurality of enclosures and the at least one RFID reader are received by a plurality of racks. The plurality of racks may be configured to receive the animal identify information and the location information. The plurality of racks may be configured to aggregate animal identity information and location information associated with a plurality of radio signals. The plurality of racks may be configured to send the aggregated animal identity information and location information associated with a plurality of radio signals, for example to the processor. The plurality of racks may be configured to power the at least one reader.

Disclosed herein is a method for locating a plurality of animals distributed between a plurality of enclosures. The plurality of animals has attached thereto a plurality of RFID tags for identifying each of the plurality of animals. The method comprises the step of distributing a plurality of RFID tag detection zones between the plurality of enclosures. The method comprises the step of a plurality of RFID antenna of the plurality of RFID tag detection zones receiving a plurality of radio signals each comprising animal identity information generated by the plurality of RFID tags attached to the plurality of animals. The method comprises the step of communicating the plurality of radio signals comprising the identity information to at least one RFID reader.

An embodiment comprises the step of sending the animal identity information of each of the plurality of radio signals and location information indicative of the detection zone associated with each of the plurality of radio signals to a processor. In a step, the processor may generate census information indicative of the distribution of the plurality of animals between the plurality of enclosures using the animal identity information and location information. The census information may be indicative of the distribution of the plurality of animals between the plurality of enclosures, and may be generated using the animal identity information and location information.

Disclosed herein is a system for locating a plurality of animals within an enclosure. The plurality of animals has attached thereto a plurality of RFID tags for identifying each of the plurality of animals. The system comprises a plurality of RFID tag detection zones. Each of the plurality of RFID tag detection zones have an RFID antenna for receiving a radio signal comprising animal identity information generated by any one of the plurality of RFID tags attached to the plurality of animals when interrogated. The RFID antenna of each of the plurality of RFID tag detection zones is in signal communication with at least one RFID reader for receiving the radio signal comprising animal identity information.

In an embodiment, the at least one RFID reader is in data communication with a processor and is configured for sending the animal identify information and location information indicative of the RFID tag detection zone associated with the radio signal to the processor. The processor may be configured to generate census information for the plurality of animals within the enclosure. The census information may be indicative of the location of each of the plurality of animals within the enclosure. The census information may be indicative of the behaviour and/or condition of the plurality of animals.

An embodiment is configured to aggregate the animal identity information and location information associated with a plurality of radio signals, and send the aggregated animal identity information and location information, for example to the processor.

Disclosed herein is a method for locating a plurality of animals in an enclosure. The plurality of animals has attached thereto a plurality of RFID tags for identifying each of the plurality of animals. The method comprises the step of disposing a plurality of RFID tag detection zones at the enclosure. The method comprises the step of a plurality of RFID antenna of the plurality of RFID tag detection zones receiving a plurality of radio signals each comprising animal identity information generated by the plurality of RFID tags attached to the plurality of animals. The method comprises the step of communicating the plurality of radio signals comprising the identity information to at least one RFID reader.

An embodiment comprises the step of sending the animal identity information of each of the plurality of radio signals and location information indicative of the detection zone associated with each of the plurality of radio signals to a processor. In a step, the processor may generate census information indicative of the location of the plurality of animals in the enclosure using the animal identity information and location information. The census information may be generated using the animal identity information and location information.

Disclosed herein is a system for locating an animal, the animal having attached thereto a radio frequency identification (RFID) tag. The system comprises an RFID tag detection zone that has an RFID antenna for receiving a radio signal generated by the RFID tag when interrogated.

Disclosed herein is a system for locating an animal, the animal having attached thereto a radio frequency identification (RFID) tag. The system comprises a plurality of RFID tag detection zones that each have an RFID antenna for receiving a radio signal generated by the RFID tag when interrogated.

In an embodiment, the system is for locating the animal relative to the plurality of RFID tag detection zones.

An embodiment comprises a RFID reader in signal communication with the RFID antenna of each of the plurality of RFID tag detection zones for receiving the radio signal generated by the RFID tag when interrogated. The RFID reader may be configured to send animal identification information and RFID tag detection zone information indicative of which of the plurality of RFID tag detection zones are associated with the animal's location. The RFID tag detection zone information may be indicative of which of the plurality of RFID tag detection zones the animal is at. The RFID reader may comprise a RFID receiver in signal communication with the RFID antenna of each of the plurality of RFID tag detection zones for receiving the radio signal generated by the RFID tag when interrogated. The animal identification information may be derived from the radio signal. The animal identification information may be derived from the radio signal by the RFID reader.

In an embodiment, the RFID reader is configured to transmit an RFID interrogation signal. The RFID reader may comprise an RFID interrogation signal transmitter configured to transmit the RFID interrogation signal. The RFID interrogation signal transmitter may be configured to transmit the RFID interrogation signal to at least one antenna of the at least one of the plurality of RFID detection zones. The RFID reader may be configured to transmit the RFID interrogation signal to the RFID antenna of one of the plurality of RFID tag detection zones before transmitting the RFID interrogation signal to the RFID antenna of another one of the plurality of RFID detection zones.

In an embodiment, the plurality of RFID tag detection zones may be within an area defined by an animal enclosure for the animal.

An embodiment comprises an animal enclosure receiver comprising the plurality of RFID tag detection zones.

An embodiment comprises an animal enclosure having a base at which are the RFID antenna of each of the plurality of RFID tag detection zones.

An embodiment comprises a pad comprising the plurality of RFID tag detection zones, the pad being for disposing beneath the animal enclosure.

In an embodiment, a radio frequency associated with the RFID tag fixed to the animal is blocked by water.

In an embodiment, the plurality of RFID tag detection zones are spaced apart in orthogonal dimensions.

An embodiment is one of a plurality of systems for locating an animal, the animal having attached thereto a radio frequency identification tag, wherein each of the plurality of systems for locating an animal is configured to send RFID tag detection zone information and animal identification information to a communications network interface. The plurality of systems for locating an animal may be each configured to receive electrical power from an electrical power interface for simultaneously powering the plurality of systems for locating an animal. The plurality of systems for locating an animal may be configured to receive the electrical power from the power interface via an electrical conduit. The power interface may comprise a back plane. The power interface may be attached to a rack for a plurality of animal enclosures.

Disclosed herein is a method for determining a location of an animal having attached thereto a RFID tag. The method comprises the step of adjacently arranging the animal and a plurality of RFID tag detection zones. The plurality of RFID tag detection zones each have an RFID antenna for receiving a radio signal generated by the RFID tag when interrogated. The method comprises the step of interrogating the RFID tag to generate the radio signal.

An embodiment comprises the step of receiving the radio signal via at least one RFID antenna of the plurality of RFID tag detection zones.

An embodiment comprises the step of deriving from the radio signal animal identification information and sending the animal identification information.

An embodiment comprises the step of sending the animal identification information to a communications network interface.

An embodiment comprises the step of storing in a data store the animal identification information so sent.

An embodiment comprises the step of generating RFID tag detection zone information indicative of which of the plurality of RFID tag detection zones are associated with the animal's location. The RFID tag detection zone information may be indicative of which of the plurality of RFID tag detection zones the animal is at. The plurality of RFID tag detection zones may be within an area defined by an animal enclosure for the animal.

An embodiment comprises the step of placing an animal enclosure receiver comprising the plurality of RFID tag detection zones in receipt of the animal enclosure.

An embodiment comprises the step of disposing the antenna of each of the plurality of RFID tag detection zones adjacent to a base of the animal enclosure.

An embodiment comprises the step of adjacently arranging a pad comprising the plurality of RFID tag detection zones and a base of the animal enclosure.

In an embodiment, a radio frequency associated with the RFID tag fixed to the animal may be blocked by water.

In an embodiment, the plurality of RFID tag detection zones are spaced apart in orthogonal directions.

Disclosed herein is a method for determining the identity of each of a plurality of animals within an enclosure. The method comprises the step of attaching a RFID tag to each of the plurality of animals. The method comprises the step of disposing the plurality of animals in the enclosure. The method comprises the step of a RFID reader receiving a response from the RFID tag attached to each of the plurality of animals.

In an embodiment, the enclosure is associated with another RFID, the embodiment further comprising the step of the RFID receiving a response from the other RFID tag.

Disclosed herein is a method for determining movement of an animal within an enclosure. The method comprises the step of attaching a radio-frequency identification (RFID) tag to the animal. The method comprises the step of disposing the animal within the enclosure which has a plurality of RFID tag detection zones associated therewith. The method comprises the step of repeatedly interrogating the RFID tag which transmits a plurality of radio signals comprising animal identification information. The method comprises the step of generating animal location information by determining which of the plurality of RFID tag detection zones are associated with the animal's location during transmission of each of the plurality of radio signals.

An embodiment comprises the step of sending the animal identification information and the animal location information.

An embodiment comprises the step of deriving the animal identification information from the radio signal.

Disclosed herein is an animal research facility comprising a plurality of animal enclosures for receiving a plurality of animals, each of the plurality of animals having attached thereto an RFID tag. Each of the plurality animal enclosures have associated therewith a RFID reader configured to receive at least one RFID tag radio signal comprising identity information indicative of the identify of those of the plurality of animals within the enclosure that the RFID reader is associated therewith.

In an embodiment, the RFID reader is in data communication with a processor and is configured to send the identity information to the processor. The processor may be configured to determine the distribution of the plurality of animals between the plurality of animal enclosures from the identity information.

Disclosed herein is non-transitory processor readable tangible media including program instructions which when executed by a processor causes the processor to perform a method disclosed above.

Disclosed herein is a computer program for instructing a processor, which when executed by the processor causes the processor to perform a method disclosed above.

Any of the various features of each of the above disclosures, and of the various features of the embodiments described below, can be combined as suitable and desired.

### BRIEF DESCRIPTION OF THE FIGURES

Embodiments will now be described by way of example only with reference to the accompanying figures in which:

FIG. 1 shows a schematic diagram of an embodiment of a system for locating an animal having attached thereto a radio frequency identification (RFID) tag.

FIG. 2 shows a plan view of the system of FIG. 1 that reveals a plurality of RFID tag detection zones.

FIG. 3 shows a side elevation view of an example of an animal enclosure.

FIG. 4 shows a plan view of the system of FIG. 1 and a plurality of systems similar and/or identical to that of FIG. 1, in communication with a communications network interface.

FIG. 5 shows an elevational side view of an example of a rack for a plurality of animal enclosures, the plurality of animal enclosures being received by a plurality of systems for locating an animal.

FIG. 6 corresponds to FIG. 5 and shows a plan view of the plurality of systems for locating an animal in signal communication and power communication with the rack.

FIG. 7 shows a schematic of an example of an animal research facility comprising a plurality of racks similar and/or identical to that of FIG. 5.

FIG. 8 shows a schematic representation of an example of a cloud virtual server architecture for a cloud virtual server in communication with the systems of FIGS. 1 and 5.

FIG. 9 shows a schematic diagram of an example of an integration architecture for the cloud virtual server of FIG. 8.

FIG. 10 shows an example of an entity relationship model (ERM) used to define the structure of a data store on the cloud virtual server that stores animal identification information determined by the systems of FIGS. 1 and 5.

FIG. 11 shows an example of the movement of information through the entities of FIG. 10.

FIG. 12 shows a screen shot of an example of a data presentation screen that presents data retrieved from a data store.

FIG. 13 shows a screen shot of an example of a graphical user interface for retrieving from the data store the identity of at least one animal in an animal enclosure on a rack.

FIG. 14 shows a screen shot of an example graphical user interface for a user to define the spatial location of RFID detection zones for the systems of FIGS. 1 and 5.

FIG. 15 shows a screen shot of an example representation of data accumulated for an animal enclosure and retrieved from the data store.

FIG. 16 shows a screen short of an example of another representation of data accumulated for an animal enclosure and retrieved from the data store.

FIGS. 17 and 18 show example user navigation options for software applications for the systems of FIGS. 1 and 5.

### DESCRIPTION OF EMBODIMENTS

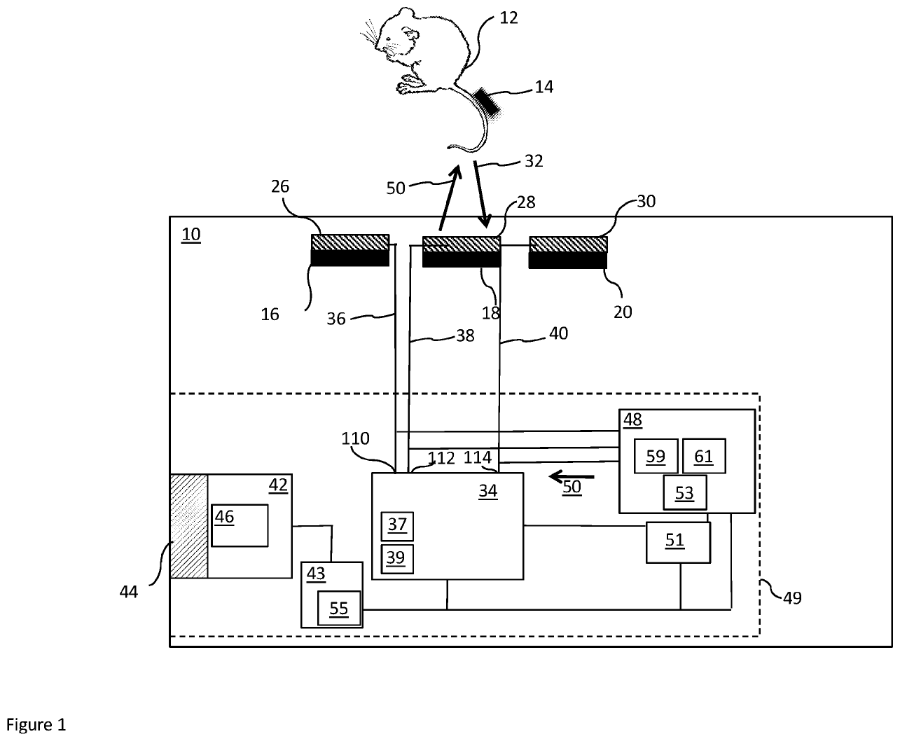

FIG. 1 shows a schematic diagram of an embodiment of a system for locating an animal, the animal having attached thereto a radio frequency identification (RFID) tag. The system is generally indicated by the numeral 10, the animal by the numeral 12 and the RFID tag by the numeral 14. The system 10 comprises a plurality of RFID tag detection zones 16,18, 20 that each have an RFID antenna 26, 28, 30 for receiving a radio signal 32 generated by the RFID tag 14 when interrogated.

The present but necessarily all embodiments is for locating the animal relative to the plurality of RFID tag detection zones. An alternative embodiment, however, only has one RFID tag detection zone that has an RFID antenna for receiving a radio signal 32 generated by the RFID tag 14 when interrogated.

The RFID tag 14 comprises an integrated circuit comprising non-volatile memory which stores animal identification information, and may also store other information ready for transmission within the radio signal 32. The antenna 26,28, 30 each comprise a fractal antenna, however the antennae may be meander antennae, line antennae or generally any suitable form of antennae. A fractal antenna is an antenna that uses a fractal, self-similar design to maximize the length, or increase the perimeter (on inside sections or the outer structure), of material that can receive or transmit electromagnetic radiation within a given surface area or volume.

The system 10 comprises an RFID reader 49 that has an RFID receiver 34 in signal communication with the RFID antennae 26, 28, 30 of the plurality of RFID tag detection zones 16, 18, 20. The RFID reader 49 is for receiving the radio signal 32 generated by the RFID tag 14 when interrogated. The radio signal 32 is generated according to an air interface protocol which may be any suitable air interface protocol, for example RAIN RFID, and EPC global UHF Class 1 Gen2/ISO 18000-63 (formerly 18000-6C). Signal communications is via electrically conductive pathways in the form of cables 36, 38, 40, or alternatively wires and/or traces for example. The electrically conductive pathways 36, 38, 40 electrically connect the RFID antennae 26, 28 and 30 and the RFID reader 49, and the RFID receiver 34 therein. Cables 36, 38 and 40 are in this embodiment co-axial cables for radio frequencies, for example UHF, received and/or transmitted by the RFID tag 14. The system 10 comprises a communication interface 42, which comprises in this embodiment a suitable physical communication interface. In this embodiment the physical communications interface comprises a connector 44 in the form of a data plug (or alternatively a data socket, for example) and associated physical layer circuitry. The communications interface 42 may optionally comprise one or more higher communication layers in communication circuitry 46 (e.g. data link and application layers of the OSI model), or these may be incorporated in the receiver 34 or other subsystem of the reader 49. The communications interface 42 may be for, for example, USB, ETHERNET, THUNDERBOLT, Bluetooth, Wi-Fi or generally any suitable form of communications interfaces and protocols. In the present embodiment, the communications interface 42 is a personal area network (PAN) in the form of a USB interface, specifically a USB 3.0 interface that also provides power to the system 10. The communications interface receives animal location information when generated.

The receiver 34 comprises an amplifier 37 that amplifies the RFID tag radio signal 32 received via the antennae 26, 28 and 30. The receiver 34 comprises a demodulator 39 that compares the modulated signal to a signal generated by an oscillator 51 of the same carrier frequency, thereby extracting a message from the radio signal 32.

The communications interface 42 is for sending animal identification information and RFID tag detection zone information indicative of which of the plurality of RFID tag detection zones 16, 18, 20 are associated with the animal's location. The RFID tag detection zone information is in this but not all embodiments indicative of which of the plurality of RFID tag detection zones the animal 12 is at. The RFID tag detection zone information comprises detection zone identification information in the form of a detection zone code, which in this embodiment comprises one or more symbols. The symbols may encode, for example, an antenna port identification for the receiver antenna port 110, 112, 114 at the receiver 34 that the zone's antenna is attached. The animal identification information is derived by the receiver 34 from the radio signal 32 generated by the RFID tag 14 when interrogated.

A RFID reader controller 43 is in signal communication with the receiver 34 and interface 42 and which is in the form of a digital signal processor is configured to process the message extracted from the signal 32 by the receiver 34 to obtain the animal identification information, and generate the RFID tag detection zone information. The RFID receiver controller 43 sends the animal identification information and the RFID tag detection zone information to a communications network interface 64 via the communications interface 42 for transmission. An application specific integrated circuit or generally any suitable logic device may be used in place of the digital signal processor. The RFID controller 43 generally controls communications with middleware and backend systems, runs the primary operation systems for the reader 49, and controls memory usage.

A code in the form of an Electronic Product Code (EPC) is stored in the RFID tag's memory, written to the tag 14 by an RFID reader, and which may take the form of, for example, a 96-bit string of data. Alternative embodiments may not store an EPC. The first eight bits may be a header which identifies the version of the air interface protocol. The next 28 bits may identify the organization that manages the data for this tag. The organization number may be assigned by the EPC global consortium. The EPC or part thereof may be used as a key or index number to uniquely identify that particular animal represented in a data store 81. In this embodiment, stored in RFID tag user memory is an object class, identifying the kind of animal the tag is attached to (e.g. “mouse” or “rat”), and a unique number for a particular tag encoded as follows:
Position 1=Gender
   0=Male
   1=Female
Positions 2-9
   Enclosure identification (2 numeric digits—00 to 99 which addresses 8 bits, 2-5 for the first digit 0-9 and positions 6-9 for the second digit 0-9)
Positions 10-18
   Strain code (00-9Z)
Positions 19-26
   Protocol identification—a two digit numeric code

The RFID reader 49 may send a string of symbols comprising, for example, the code, last seen time for the tag 14, last seen date for the tag 14, first seen time for the tag 14, first seen date for the tag 14, received signal strength indicator (RSSI), Protocol control (PC) and a cyclic redundancy check (CRC).

In the present embodiment, but not all embodiments, when an antenna is activated when adjacently disposed to a plurality of RFID tagged animals, the antenna will capture and transmit to the reader:
The date and time the antenna was activated
The antenna's unique identification (UID)
The EPC codes of the RFID tags which may include one or more animal tag EPC and the enclosure RFID tag EPC code
Data in the user memory portion of the RFID tag.

Alternatively, only an identification portion of the EPC code may be transmitted.

The RFID reader 49 comprises an RFID interrogation signal transmitter 48 configured to transmit an RFID interrogation signal 50 to at least one of the RFID antennae 26, 28, 30 of the plurality of RFID tag detection zones 16, 18, 20. The signal is radiated by at least one of the antennae. The RFID interrogation signal 50 uses an air interface protocol which may be any suitable air interface protocol. The RFID interrogation signal transmitter 48 may comprise a base band transmitter 59 to generate the interrogation signal 50, a power amplifier 61 to amplify the carrier signal produced by the oscillator 51 and a modulator 53 to modulate the amplitude, frequency or phase of the carrier signal. While system 10 is monostatic, other embodiments may be bistatic (that is separate antennae for transmitting the interrogation signal 50 and receiving the radio signal 32) or multistatic, for example.

In this but not all embodiments, the RFID interrogation signal transmitter 48 transmits the RFID interrogation signal 50 to the RFID antenna 26, 28, 30 of one of the plurality of RFID tag detection zones 16, 18, 20 before transmitting the RFID interrogation signal 50 to the RFID antenna 26, 28, 30 of another one of the plurality of RFID detection zones 16, 18, 20. The controller 43 determines if the RFID radio signal 32 is received by the same antenna 28 that transmitted the RFID interrogation signal 50. This may be achieved, for example, by the RFID reader controller 43 listening for the RFID radio signal 32 with the antenna that transmitted the interrogation signal 50 at an expected radio signal arrival time, and if the radio signal 32 is detected store in memory 55 RFID detection zone identification information for the RFID detection zone having the antenna. The memory 55 may be on board or out board of the controller 43. The RFID interrogation signal 50 may be sequentially transmitted via the antennae of the plurality of detection zones 16, 18, 20. The sequence in which the antennas transmit the interrogation signal 50 may be a predetermined order, or may be a random or quasi-random order. Two or more antennae may simultaneously transmit interrogation signal 50, for example antenna at opposite sides of the enclosure so that location confusion is negligible, which may increase the rate at which location information can be generated.

In an alternative embodiment, the RFID reader 49 comprises a host logic device and at least one RFID reader chip in the form of an IMPINJ INDY RS2000 reader chip or generally any suitable form of reader chip. The RS200 has 4 monostatic ports, which may require RFID tag detection zones to be inactive, or the use of more than one RS200 so that more than 4 detection zones may be used, or switches so that more than one antenna can use a port. When using the IMPINJ INDY RS2000 reader chip, a MONZA R6-P RAIN RFID tag chip, for example, may be attached to the animal, however generally any suitable RFID tag may be used. The host is in communication with the reader chip via a UART serial interface or generally any suitable interface. The host comprises a RASBERRY PI, however any suitable host may be used, including QUALCOMM Dragonboard 410c, system-on-a-board and microcontrollers, an example of which is the MSP430 IRI-LT host microcontroller.

In the alternative embodiment, the Impinj Indy application called ‘inventory_live’ is modified to select and utilize a specific antenna port, either port 0 or port 1. This creates two new applications called inventory_live_antport0.exe and inventory_live_antport1.exe to read specifically from antenna port 0 and antenna port 1 respectively. To read RFID tags from antenna port 0, the reader 49 executes the inventory_live_antport0.exe application and to read RFID tags from antenna port 1 the reader 49 executes the inventory_live_antport1.exe application.

In the alternative embodiment, the reader 49 comprises a printed circuit board assembly (PCBA) comprising the host logic device, RFID reader chip, and firmware. Traces on the PCB electrically connect the host and the RFID reader chip. A user interface for the reader 49 may be presented on a smart phone or tablet computer, for example. The system 10 of FIG. 1 has a similar construction, however alternative constructions may be used.

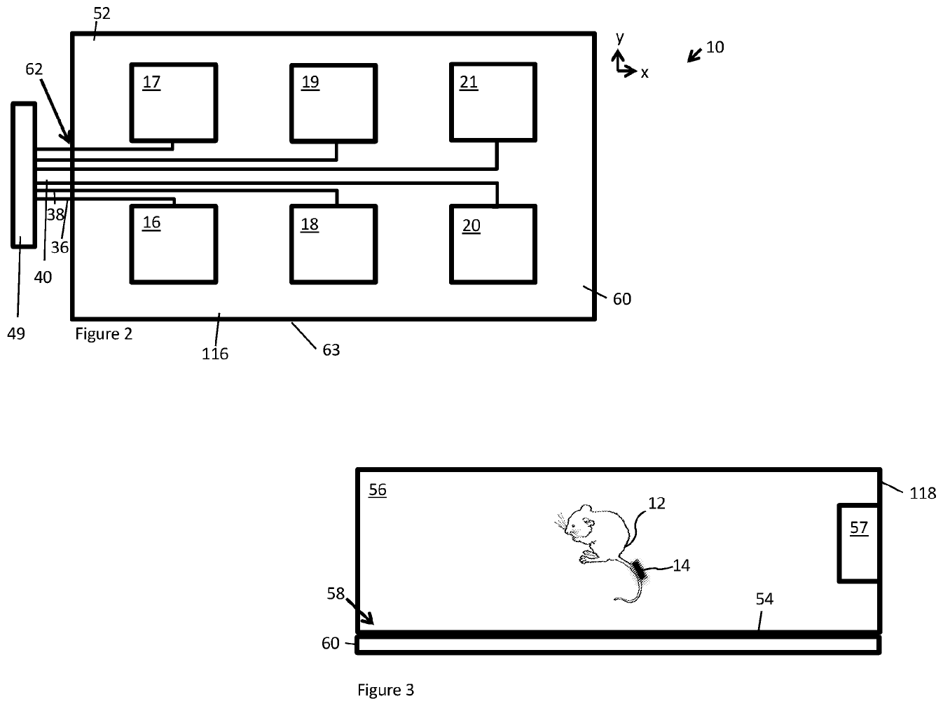

FIG. 2 shows a plan view of the embodiment of FIG. 1 revealing that the plurality of RFID tag detection zones of the system 10 include RFID tag detection zones 16, 17, 18, 19, 20, 21, and that the plurality of RFID tag detection zones are spaced apart in orthogonal dimensions x, y. The plurality of RFID tag detection zones 16-21 are within an area 52 bounded by perimeter 63, and having similar area to that of an animal enclosure for the animal. As shown in FIG. 2, the plurality of RFID tag detection zones 16-21 may be in a first unit, and the RFID reader 49 may be in a second unit. The first and second unit may be in communication with each other via electrical pathways 36, 38 and 40, for example in the form of RF cables. The second unit, for example, may comprise an enclosure housing the RFID reader 49. Alternatively, the system may comprise a single unit.

FIG. 3 shows a side elevation view of an example of an animal enclosure 56 in the form of a cage. The base 54 of the enclosure 56 has the same area as area 52, however area 52 may be less than or greater than the area of base 54. Generally, the areas are similar, for example within 5%, 10%, 25% or 50% of each other, however they need not be in all embodiments. Other embodiments of the enclosure 56 may have a base of a geometry other than rectangular, for example circular or generally any suitable geometry. The area 52 may have a geometry similar to that of base 54. The RFID antennae of the plurality of RFID detection zones 16-21 are in use adjacent, attached or embedded to the base 54 of the enclosure. They may be resting on the inside bottom 58 of the enclosure 56, within the base 54, or underneath the base 54, or generally have any suitable disposition relative to the enclosure 54.

The system 10 is configured to have an RFID tag interrogation range that is substantially confined to the enclosure 56 when received thereby and preferably within each RFID detection zone 16-21.

The boundary 63 of area 52 is, in this embodiment, the perimeter of a pad 60 comprising the plurality of RFID tag detection zones 17-21. The pad 60 is for disposing relative to (e.g. beneath) the animal enclosure 54. The enclosure may rest on the pad 60. The antennae may be in one layered sheet or a plurality of layered sheets. The pad 60 comprises an animal enclosure receiver 116 comprising a major exterior surface of the pad 60 on which the base 54 of the enclosure 56 may rest. The pad 60 may comprise the antennae 26,28,30 printed on polymer in the form of kapton, the antennae being associated with RFID tag detection zones 17, 19 and 21. The pad 60 has electrical connectors 62 in the form of radio frequency electrical connectors. In this but not all embodiments the radio frequency electrical connectors are coaxial RF connectors, examples of which include but are not limited to SMA and UHF connectors. Alternatively, the cables 36, 38, 40 may not be terminated by connectors and may be terminated at electrical components within the first and second units.

The enclosure 56 is associated with another RFID tag 57. The other RFID 57 is at the enclosure, and is in this but not all embodiments attached to the enclosure 56, for example attached to the bottom 54 or a side wall 118, or generally at any suitable location. In the present embodiment, an enclosure card attached to the enclosure 56 comprises the RFID tag 57. The RFID reader 49 may receive a response from the other RFID tag 5, for example via one of the antennas 26, 28, 30. The other RFID tag 57 comprises enclosure information comprising enclosure identification information that can be read by the system. Consequently, the enclosure identification information may be sent to the computing system 80 and associated (in the context of a relational database of computing system 80, “associated” is understood to have the same meaning as “related”) with animal identity information for the animals in the enclosure by the computing system which is configured to do so. Alternatively, the enclosure is identified by the associated reader's identification.

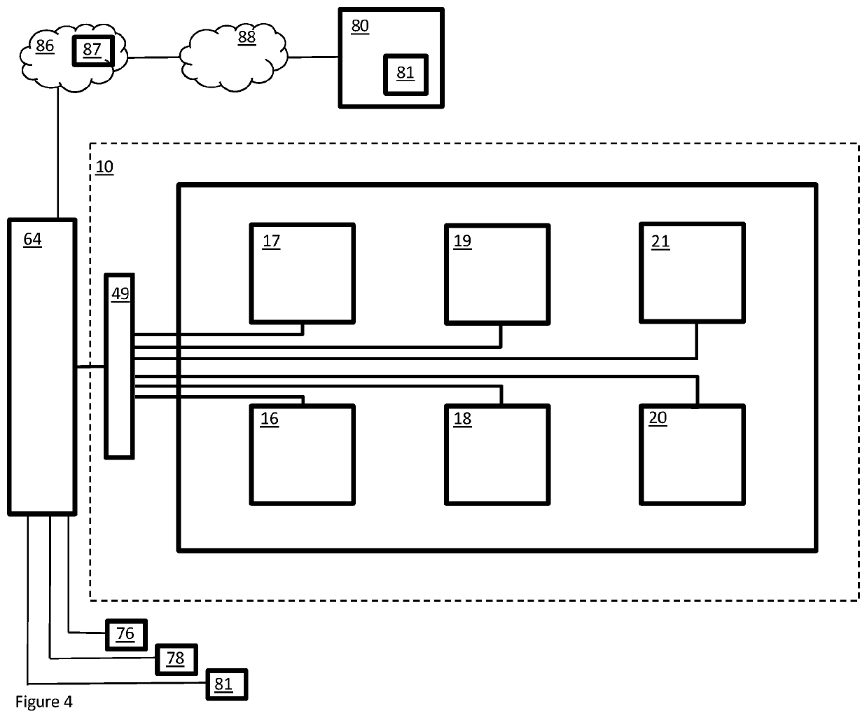

FIG. 4 shows a plan view of the system 10 in communication with a communications network interface 64. The system 10 is one of a plurality of systems 10, 76, 78, 81 for locating an animal 12 having attached thereto a radio frequency identification tag 14. Each of the plurality of systems 10, 76, 78, 91 is suitable for locating more than one animal in each enclosure. Systems 76, 78 and 81 are identical to system 10, however they may be different. Each of the plurality of systems 10, 76, 78, 81 are each configured to send RFID tag detection zone information and animal identification information to the communications network interface 64. The communications network interface 64 is in communication with the reader 49 of each of the plurality of systems 10, 76, 78, 81 via a personal area network in the form of a Universal Serial Bus (USB 3.0, for example), however any suitable communications channel including Bluetooth may be used. The reader 49 and the communications interface have personal area network interfaces. ASCII or XML encoded data is sent by the reader 49 to the communications network interface 64. Other encoding schemes may be used. The encoded data may be encrypted using, for example, an Advanced Encryption Standard. The communications network interface 64 connects the systems 10, 76, 78, 81 to a network 86 in the form of a local area network, which comprises a meshed radio network in the form of a DUST wireless network. Any suitable network may be used, examples of which include but are not limited to a personal area network (e.g. a Universal Serial Bus network, a BLUETOOTH network, a FireWire network), packet-switched networks, a local area network (e.g. an Ethernet network defined by the standard IEEE 802.3 or a variant thereof, a Wi-Fi network defined by the standard IEEE 802.11 or a variant thereof, a Fibre Channel network), a metropolitan area network, a wide area network (e.g. packet over SONET/SDH, MPLS, Frame Relay), or another meshed radio network, for example, a ZIGBEE network. The network 86 has a gateway 87 in the form of a router for example, or a cellular or generally any suitable connection, for connecting with another network 88 to which a remote computing system 80 is connected. The other network 88 comprises in this but not all embodiments an internetwork in the form of the Internet. Intermediate the gateway 87 and the communications network interface 64 may be at least one radio network node. The computing system 80 may be in the form of a computer server (for example in the present embodiment a cloud virtual computer server or cloud computing service, such as those provided by Microsoft's Azure service or Amazon, or a physical computer server) which is running RFID data analysis software that sends and receives data, and may control which antennae are active, and how frequently the antennas are active. Shown in FIG. 4 is an example of an internetwork comprising the networks 86 and 88 (and in this but not all embodiments the networks connecting the readers 49 to the communications network interfaces 64), the systems 10, 76, 78 and 81, and the processor 80. In this embodiment, the internetwork comprises three networks.

In an alternative embodiment, the RFID reader 49 is in communication with a computing device in the form of, for example, a general purpose computer (e.g. a personal computer, a laptop etc.), a smart phone, tablet computer or generally any suitable device. The RFID reader may be in communication with the computing device with a personal area network, for example a USB or Bluetooth connection.

The communications network interface 64 comprises a processor in the form of a QUALCOMM Snap Dragon system-on-a-chip hosting Windows 10 IOT core and running computer programs including applications written in C #, and a system side communication interface and a server side communications interface, each of which comprise a physical layer interface. The communications network interface 64 may generally use any suitable hardware and/or software. The computer program configures the processor. One alternative embodiment uses a microcontroller or RASBERRY PI with LINUX OS. The communications network interface 64 may comprise memory for storage of information received from any one of the plurality of systems 10, 76, 78, 81 in case the network is unavailable. The communications network interface processor is configured to retrieve and send the stored information when the network becomes available. Each communications network interface 64 comprises an optional location radio in it. The location radio (Deca Wave, for example) may allow the location of the communications network interface 64 to be known within around 30 cm or so at very low power consumption. Power may be provided to the communications network interface 64 by an AC power source or rechargeable batteries, for example.

The communications network interface 64 processor is configured to aggregate animal identity information and animal location information in the form of RFID tag detection zone information from the plurality of systems 76, 78, 81, and send the aggregated information to the computing system 80. In this embodiment, information for each animal repeatedly collected over a period of time (for example, 1 minute, 2 minutes, between 1-15 mins) and aggregated into a data package. The aggregated information in this embodiment comprises interrogated RFID tag information, for example the RFID tag identification indicative of animal identification, user memory information, animal location information, antenna identification information for each RFID tag, date and/or time, enclosure RFID tag information, for example enclosure RFID tag identification and user memory information (for example rack identification information and enclosure rack position information). The aggregated information in other embodiments may comprises more, less, or different information. The data package having the aggregated information enables the processor 80 to at least one of confirm which animals are in which enclosure in which racks, and provide position data over a time period which will enable animal track mapping as graphically represented in FIG. 16, for example. The aggregated information is generally as in this embodiment, but not necessarily in all embodiments, stored in memory in the form of addressable memory, and specifically addressable memory 55 resident on the reader printed circuit board assembly of the reader 49. If the data connection to the processor fails, information may still be collected and stored. The stored information may be later transmitted when the data connection is restored. The aggregated data may take the form of an array of records, for example. In one form, the aggregated data is in the form of a table. The overall system shown in FIG. 4, for example, enables animals in many enclosures to be simultaneously located. The number of systems in the plurality of systems 10, 76, 78, 81 may be greater than 1, greater than 10, greater than 100 and greater than 1,000. There may be less than 1,000,000 enclosures, however there may be more. There may be hundreds, thousands or even millions of animals in the enclosures. The processor 80 can process and store information for all of the plurality of systems and the plurality of animals.

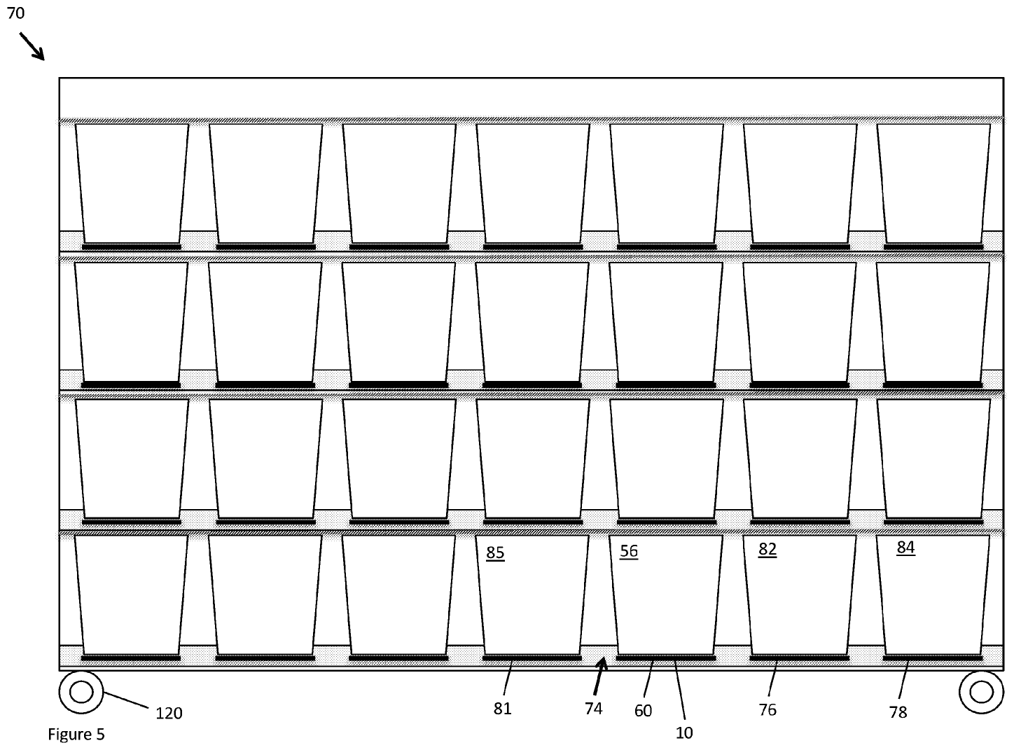

FIG. 5 shows an elevational side view of a rack 70 for a plurality of animal enclosures 56, 82, 84. The rack 70 has received the plurality of systems 10, 76, 78, 81 and other similar or identical systems. For example, the systems 10, 76, 78, 81 may be mounted, attached and/or integrated to a rack shelf 72. An upper surface 74 of the rack shelf 72, for example, is an enclosure receiver. In this embodiment, however, the pads (e.g. pad 60) of the systems 10, 76, 78, 81 are placed on the upper surface 74 of the rack shelves 72 beneath the enclosures 56, 82, 84, and 85.

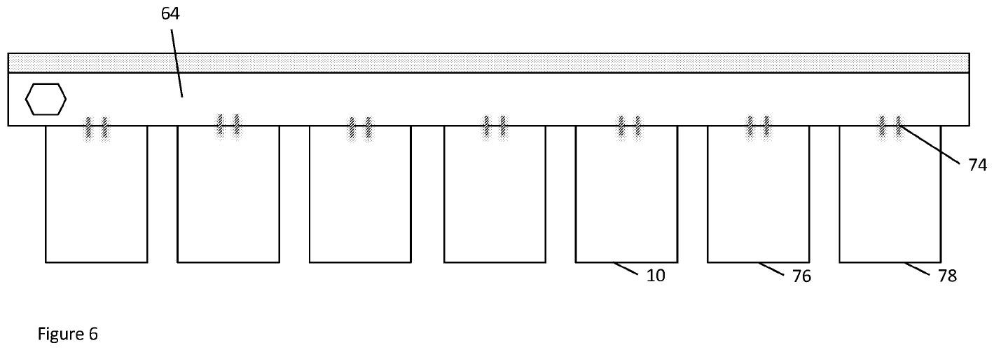

FIG. 6 corresponds to FIG. 5 and shows a plan view of the plurality of systems 10, 76, 78, 81 for locating an animal in signal communication and power communication with the rack 70. The plurality of systems 10, 76, 78, 81 are resting on rack shelf 72, and other systems are resting on the other rack shelves. The plurality of systems 10, 76, 78, 81 are connected to the network communications interface 64 via connectors in the form of mechanical connectors 74 that provide a communication interface in the form of a USB connector, or alternatively a thunderbolt, or generally any suitable form of connector, between the plurality of systems 10, 76, 78, 81 and the network communications interface 64. The USB mechanical connectors 74 also provide electrical power. Alternative embodiments comprise a separate power interface in the form of an electrical power socket to power the plurality of systems 10, 76, 78 81. The USB interface may provide power. In this but not all embodiments, the network communications interface 64 is part of the rack. In an alternative embodiment, the power may be otherwise supplied and the information not sent via the rack 70.

The plurality of systems may be each configured to receive electrical power from the electrical power interface via at least one of a cable and a back plane, for example. In an alternative system, the systems 10, 76, 78, 81 use a wireless communications protocol, for example Bluetooth, to connect to the network communications interface 64. The rack 70 has optional wheels 120.

In the various embodiments and examples described herein, a system 10 that have multiple detection zones may be replaced with an embodiment of a system having a single detection zone and antenna. This may be used to locate an animal to an enclosure of a plurality of enclosures.

A radio frequency associated with the RFID tag 14 fixed to the animal 12 is blocked by water. Generally, but not necessarily, the radio frequency is the carrier frequency for information transmitted by the RFID tag. If the animal enclosure 56 collects water (e.g. from a defective automated watering system), the RFID signal from the RFID tags attached to animals within the enclosure 56 is disrupted as electromagnetic waves at Ultra High Frequencies (UHF) are attenuated by water. The computing system 80 monitors for a loss of RFID tag reads from animals in each enclosure (or if an RSSI satisfies a RSSI condition, for example a minimum RSSI signal value) and, if there are no RFID tag reads for longer than a threshold period, the computing system 80 is configured by a computer program to generate an alert, for example a laboratory technician may be alerted on screen, by email or by a text message. The laboratory technician may then intervene before the animals experience hypothermia or other health risks caused by enclosure floods.

An embodiment of a method for determining a location of the animal 12 having attached thereto a RFID tag 14 will now be described. The embodiment of the method may be performed using any of the systems 10, 76, 78, and 81 for example. The method comprises the step of adjacently arranging the animal 12 and a plurality of RFID tag detection zones 16,18,20. The method may comprise the step of interrogating the RFID tag 14 for generation of the radio signal 32.

Optional steps of the embodiment of the method for determining a location of an animal 12 will now be described. The radio signal may be received via at least one RFID antenna 28 of the plurality of RFID tag detection zones 16, 18, 20. Animal identification information may be derived from the radio signal 32 and sent. The animal identification information may be sent to the communications network interface 64. The animal identification information sent may be stored in a data store within the communications network interface 64 and/or the data store 81 of the remote computing system 80. RFID tag detection zone information is generated that is indicative of which of the plurality of RFID tag detection zones 16, 18, 20 are associated with the animal's location. The RFID tag detection zone information may be indicative of which of the plurality of RFID tag detection zones the animal is at.

In some embodiments of the method, the animal enclosure receiver 116 is placed in receipt of an animal enclosure 56. For example, the pad 60 may be placed in contact with the enclosure 64, for example placed in contact with the base 54 or placed on the inside bottom 58 of the enclosure. Alternatively, the animal enclosure 56 may be supported above the pad 60.

An embodiment of a method for determining the identity of each of a plurality of animals within an enclosure 56 will now be described. The method may, for example, be performed using any of the systems 10, 76, 78, 81, for example. A step of the embodiment of the method comprises attaching a RFID tag 14 to each of the plurality of animals and disposing the plurality of animals in the enclosure 56. A step comprises a RFID reader 49 receiving a response from the RFID tags attached to the plurality of animals disposed in the enclosure. Generally, but not necessarily, each animal will have one RFID tags.

Alternatively, a laboratory technician, for example, may place the animal directly on a working surface 116 of pad 60 while working on an animal with both hands, and at the same time have the animal identified.

An embodiment of a method for determining movement of the animal 12 within the enclosure 56 will now be described. The method may be performed using the system 10, for example. The embodiment of the method comprising the step of fixing the radio-frequency identification (RFID) tag 14 to the animal 12. A step comprises of disposing the animal 14 within the enclosure 56 which has a plurality of RFID tag detection zones 16, 18, 20 associated therewith. The method comprises the step of repeatedly interrogating the RFID tag 14 which transmits a plurality of radio signals 32 comprising animal identification information. The method comprises the step of generating animal location information by determining which of the plurality of RFID tag detection zones 16, 18, 20 are associated with the animal's location during transmission of each of the plurality of radio signals. The method comprises the step of sending the animal identification information and the animal location information.

The computing system 80 stores the received location of the animal 12 or of each of the plurality of animals within the enclosure or plurality of enclosures at each time the RFID tags 14 are interrogated to generate a location data set. The data set is stored in a data store 81 in the form of a database. The location for the animal or each plurality of animals can be repeatedly determined and a time sequence of animal location information for the animal 12 or each of the plurality of animals generated and stored in the computer system 80 for retrieval and use. The time sequence of animal location information may be stored, for example, in incrementally indexed records within the database 81. Alternatively, the time sequence of animal location information may be stored in a file for each of the plurality of animals. Generally, the location information may be stored in any suitable way. The computing system 80 comprises the data store 81, but not in all embodiments. The movement of the animal 12 or each of the plurality of animals can be determined. The movement of each animal may be represented as a pattern of movement. The location data sets comprising a time sequences of animal location information may be used to determine a behaviour pattern from which are generated normalised behaviours based on movements over given time periods. The processor analyses behaviours against a pattern map of normal behaviour and send an electronic alert to, for example, alert a laboratory technician on screen, by email or by a text message, if the behaviour of an animal is aberrant. This may enable prompt action to be taken if an animal's health is poor.

A statistical analysis of the animal identification information and the associated detection zone information may be performed. For example, the distribution of time the animal spends in each zone 16, 18, 20 may be determined for a period. The distribution of time the animal spends in each zone 16,18, 20 may be determined for another period. The distributions in the first period and the second period may be compared. A difference in the distributions may indicate that the animals' condition has changed. In another example, the proportion of time an animal spends in a detection zone known to have at least one of a nest, cage enrichment device in the form of a wheel or house for example, food, or water, may be indicative of the animal's activity level and/or condition.

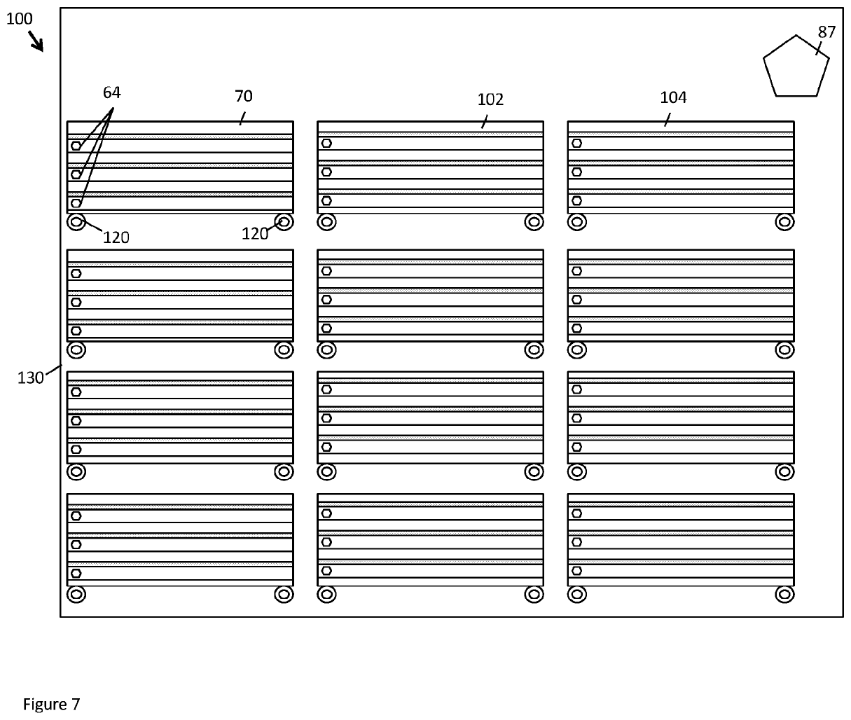

FIG. 7 shows a schematic of one embodiment of an animal research facility 100 (which may be in the form of an animal research laboratory). The animal research facility 100 comprises a plurality of racks including racks 70, 102, 104, each of the plurality of racks being for receiving more than one animal enclosure. The racks 70, 102, 104 have a plurality of levels for the plurality of animal enclosures. Each rack 70, 102, 104 has a communications network interface 64 in communication with the gateway 87 as described with respect of rack 70. In an alternative embodiment, each rack has a gateway 87 in communication with the communications network interfaces 64 of that rack. In this but not all embodiments, each rack has a plurality of rack shelves. Each rack self has a communications network interface 64. Each shelf of each of the plurality of racks 70, 102, 104 may be used as described above with reference to rack 70.

The animal research facility 100 comprises a plurality of animals distributed between a plurality of animal enclosures. The plurality of animal enclosures are distributed between the plurality of animal racks 70, 102, 104. Each of the plurality of animals has fixed thereto an RFID tag and each of the animal enclosures has associated therewith a RFID reader in data communication with a processor in the form of the computing system 80. The RFID readers are configured to receive identity information indicative of the identify of those of the plurality of animals within the associated enclosure and send the identity information. The animal enclosures are at their respective RFID reader in this but not necessarily all embodiments. The identity information is sent to the computing system 80, which is configured to use the identity information to determine the distribution of the plurality of animals between the plurality of animal enclosures. The RFID reader may be the system 10, for example, a commercially available RFID reader, or generally any suitable RFID reader. The enclosure may be identified by reading an associated enclosure tag as described, or by using system identification information for the system that has received the enclosures. The system identification information may be stored in memory 55.

Consequently, the system may provide an automated way to provide a total count of individual research animals across an entire facility, thereby replacing the current art which relies on a human visually observing and counting animals periodically.

It will be appreciated that the animal research facility 100 comprises a system 130 for locating a plurality of animals, for example mouse 12, distributed between a plurality of enclosures 85,56, 82,84. The plurality of animals 12 have attached thereto a plurality of RFID tags, for example RFID tag 14, for identifying each of the plurality of animals 12. The system 130 comprises a plurality of RFID tag detection zones, for example 17-21, distributed between the plurality of enclosures. Each of the plurality of RFID tag detection zones 17-21 have an RFID antenna for example 26,28,30, for receiving a radio signal 50 comprising animal identity information generated by any one of the plurality of RFID tags 14 attached to the plurality of animals 12 when interrogated. The RFID antenna 26, 28, 30 of each RFID tag detection zone are in signal communication with at least one RFID reader 49 for receiving the radio signal 32 comprising animal identity information.

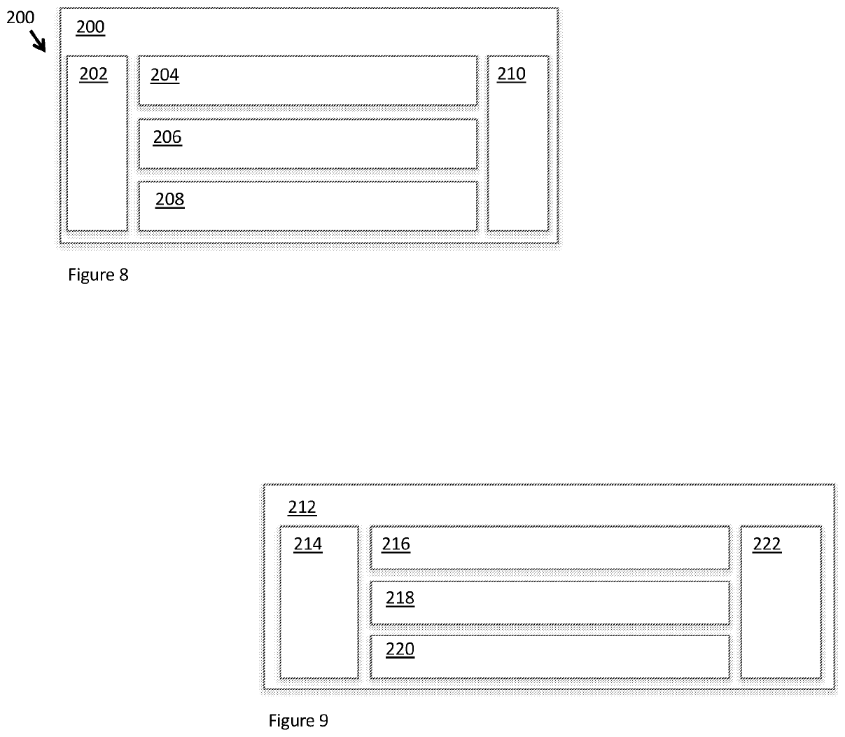

The computing system 80 may be a cloud virtual server. FIG. 8 shows a schematic representation of an example of a cloud virtual server architecture 200, examples of which include AZURE, AMAZON, etc. however a private cloud virtual server may be used. The cloud virtual server has a N tier architecture, in which presentation, application processing, and data management functions may be physically separated. It has a service orientated modular architecture. The architecture 200 includes, but is not necessarily limited to, an integration services module 202, a user interface module 204, a business logic module 206, data storage, access and query module 208, and a security services module 210. The cloud virtual server architecture provides infrastructure services (hosting, DR, storage, CPU, RAM, Firewalls etc.). FIG. 9 shows a schematic diagram of an example of an integration architecture 212 for the cloud virtual server 200. An Azure internet of things (IoT) hub manages connectivity to each of the plurality of systems 10, 76, 78, 81. The integration architecture 212 includes a communications network interconnect (e.g. AZURE IOT Hub) 214, a data encryption and decryption module 216, a communications network interface module 218 for transforming census application data between for example ASCII, XML and JSON, a RESTful API 220 in the form of a data loader to the database, and an Open API 222 for data download.

In the disclosed but not necessarily in all embodiments, each rack has a rack identification comprising at least one symbol that may be a unique rack identification. The rack identification may be encoded in a radio frequency identification tag at and/or attached to the rack that is read by the readers thereat. Each rack self has a rack shelf identification that may be a unique rack shelf identification. Each enclosure has an enclosure identification that may be a unique enclosure identification and may comprise at least one symbol. The enclosure identification may be stored in an RFID tag at and/or attached to the case.

Each communications network interface 64 has a communications network interface identification comprising at least one symbol that may be or derived from an address for the communications network interface 64, for example an internet protocol or MAC address for the communications network interface 64. The communications network interface identification may be unique.

Each of the systems 10, 76, 78, 81 has a system identification comprising at least one symbol. The system identification may be unique. The system identification may generally, but not necessarily, be stored within an operating system for the system 10 within system memory.

Each antenna has an antenna identification comprising at least one symbol. The antenna identification may be unique for each reader. The antenna identification may be an antenna port identification. For example, a system with system identification 27 may have antenna ports 1,2,3 and 4 with unique antenna identifications 27-1, 27-2, 27-3 and 27-4. The RFID detector zones may be identified by their associated antenna port identification.

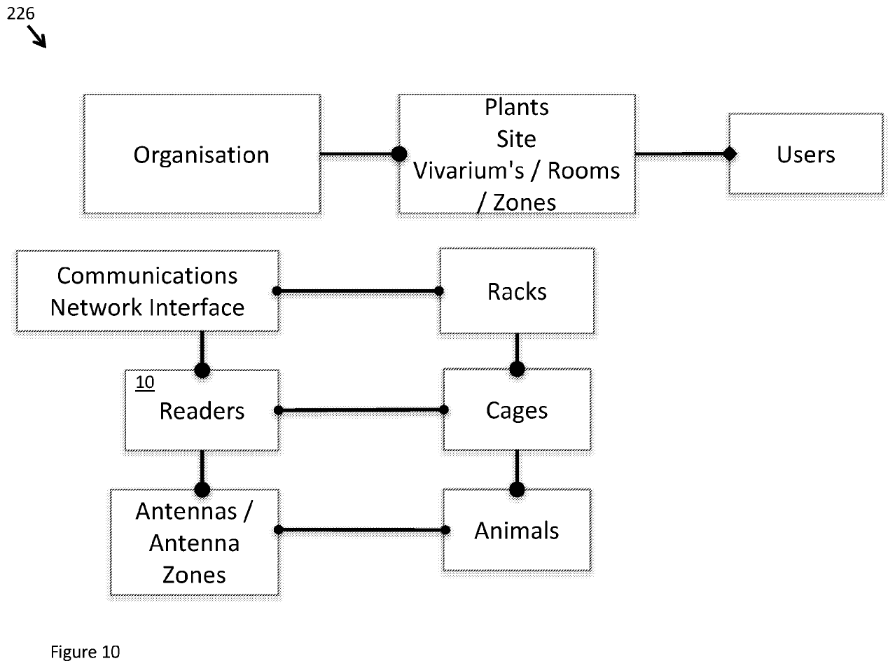

Identification information for individual components described herein generally but not necessarily are stored in the database 81 and associated. The relationships between entities in the data store 81 may be defined, by for example importing a spreadsheet to populate the database 81, or via a graphical user interface. FIG. 10 shows an example of an entity relationship model (ERM) 226 which shows the relationship of the systems 10 to other entities. The entity relationship model is used to relate database tables within the data store 81.

The systems send the identification information of the components to the computing system 80. In the present embodiment, but not all embodiments, within the database 81:
Animal enclosures are associated to a rack shelf and a rack, using the identifications or other symbols as indexes or keys
Communication network interfaces are associated to a rack shelf and a rack, using the identifications or other symbols as indexes or keys
Systems are associated to a rack, rack shelf and enclosure ID, using the identifications or other symbols as indexes or keys
Each antenna is associated to a system 10, using identifications or other symbols as indexes or keys.

The computing system 80 is optionally configures to relate the received identification information. The database comprises a data definition for the components.

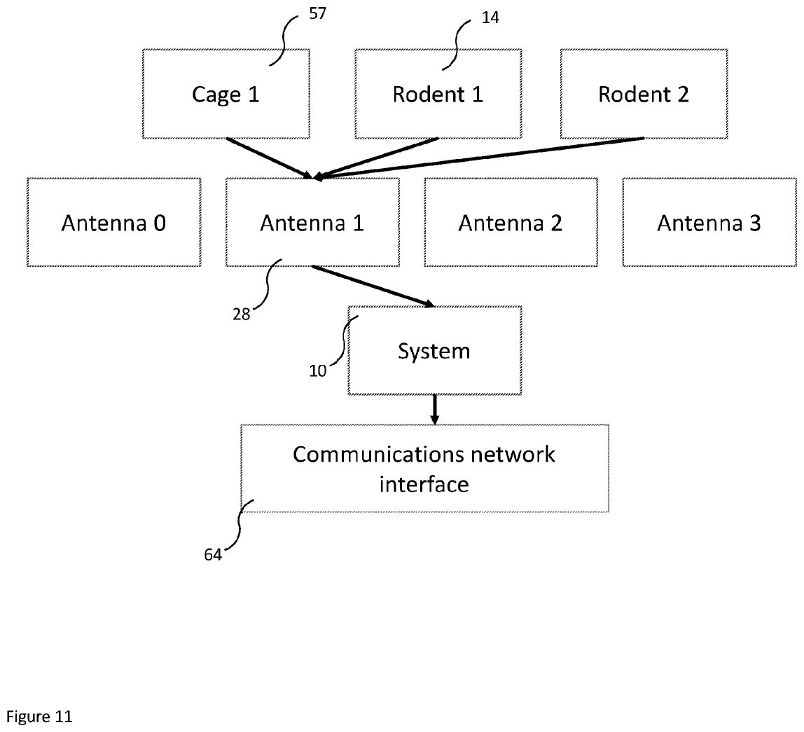

FIG. 11 shows an example of the movement of information through components. Identification information is sent by the animal's RFID tag 14 and enclosure RFID 57 and received by an antenna 28. The information is then received by the system 10, 76, 78, 81 which sends the information to the communications network interface 64. Before the system 10, 76, 78, 81 sends a packet in the form of a data packet to the network communications interface 64, it will append its identification, for example it's network address (e.g. internal IP address), to the data packet.

The database 81 stores the data received from the system's 76, 78, 81 communications network interface 64, wherein the identities of the systems 76, 78, 81 have been associated in the database 81 with the identities of the rack shelf and the rack they are received by. Generally, but not necessarily, it is the practice in vivaria to determine which racks are in which rooms, in which zone in a zoom, and which cages are on which rack. Rack shelf and position thereon may also be determined. The association of the systems 76, 78 and 81 to the identification of the racks and/or rack shelves may be performed by a user of the database 81 via, for example, a cloud computing application. The association may be keyed in the database directly, for example, or entered into an electronic table in the form of a spreadsheet file subsequently uploaded into the database.

The computing system 80 has stored in memory thereof at least one program in the form of at least one software application for instructing the computing system 80. In this embodiment, one software application is a configuration application, that defines a user interface in the form of a graphical user interface presented by a web browser on a user's computer in communication with computing system 80, for example. The user can interact with the graphical user interface to configure at least one or all of the systems 10,76,78, 81, the network communication interfaces 64, and the computing system 10. In the present embodiment, the user can define:
which RFID readers and which of their antennas are active
how often each reader activates each antenna (i.e. the frequency of read, period of read, which may be in seconds, minutes or hours)
the start and end time for a data collection period (e.g. 6:01 AM 1 Sep. 2025 to 7:04:11 PM 2 Sep. 2025
The sequence in which the antennas are activated.

Another software application is an information collection application for collection of information from the systems 10, 76, 78, 81. The information collection application:
Reads configuration information generated by the configuration application and sends electronic instructions to put in effect the configuration.
Sends a trigger message to each system 10, 76, 78, 81 to run an executable file stored thereon, which instructs the systems to interrogate the RFID tags and transmit the information from the RFID tags to the communications network interface 64 which forwards the information.

A user may interact with the application with, for example, a web browser or custom application on the user's computer.

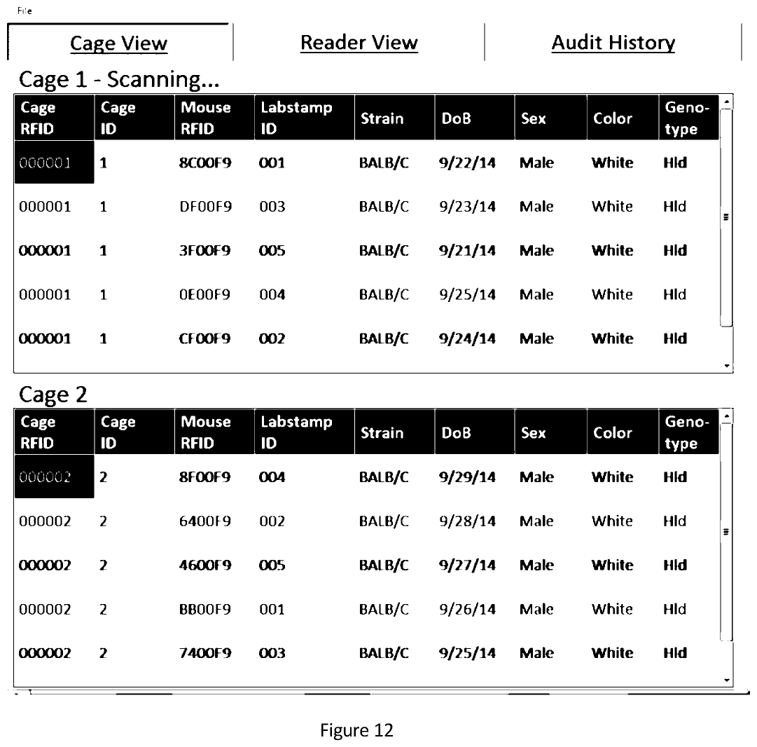

FIG. 12 shows a screen shot of a data presentation screen tabulating enclosure ID, animal ID, animal strain, date of birth (DoB), sex, colour and genotype. In this example, an animal with identification 6400F9 has been detected in enclosure 1 but should be in enclosure 2. This anomaly is indicated on the screen with red highlighting. A message in the form of a Short Message Service (SMS) text may be send to a responsible person, for example.

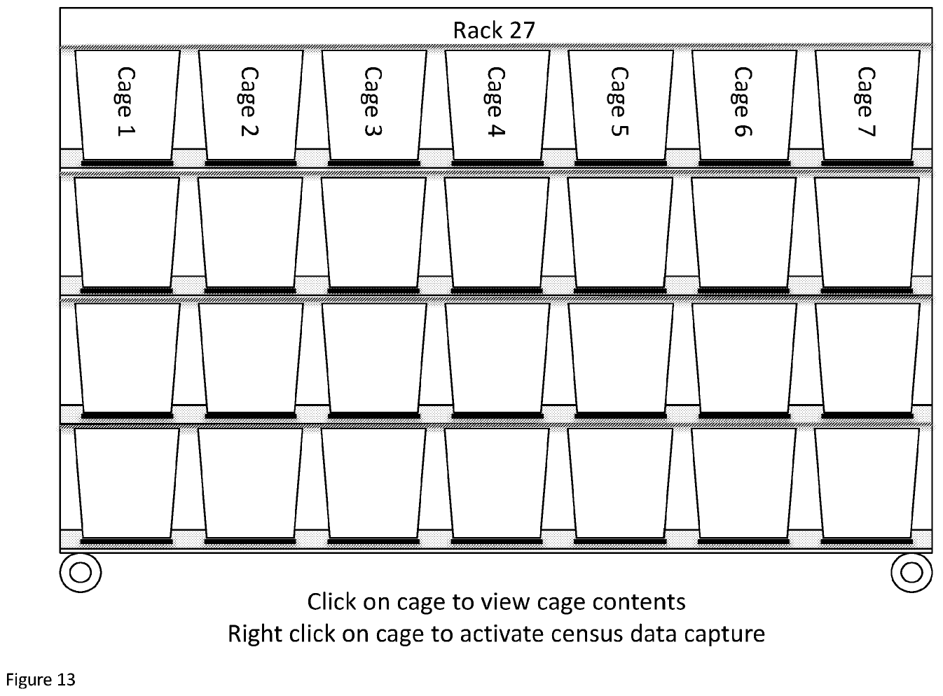

FIG. 13 shows a screen shot of a graphical user interface on the web browser on the user's computer that displays a graphical representation of a rack and the plurality of animal enclosures thereon. Each graphical representation of an animal enclosure of the plurality of enclosures is selectable by the user, in this embodiment clickable using, for example, a mouse or track pad. Selecting a graphical representation triggers the display on the graphical user interface of information stored in the data store 81 associated with the animals within those of the plurality of animal enclosures selected (see FIG. 12). One or more enclosures may be selected. The information may include, for example, animal identification information and other information retrieved from the RFID tags, which may include strain, gender and date of birth, for example. Selecting a graphical representation using an alternative selection process, for example selection by clicking using a secondary button (for example a “right click” on a mouse configured for a right handed person, or a “left click” with a modifier key on a keyboard depressed), may trigger the readers 49 to interrogate the tags 14 of the animals 12 within the racked animal enclosures.

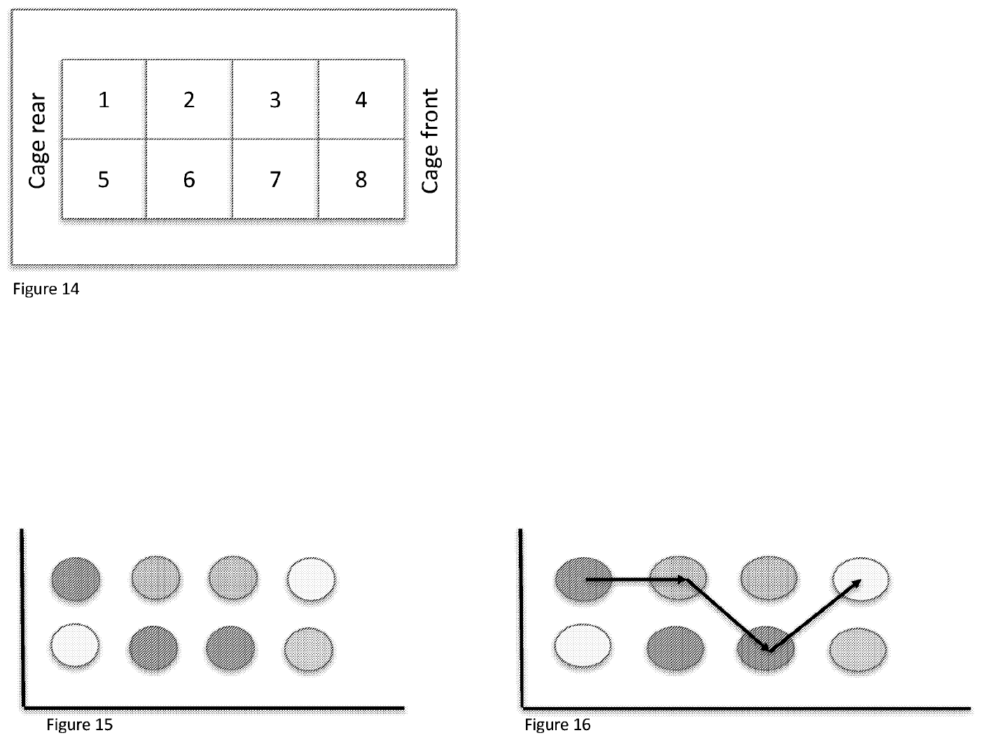

FIG. 14 shows a screen shot of an example graphical user interface for a user to define the spatial location of each detection zone, which generally results in the segmentation of the antenna readings into spatial areas beneath an animal enclosure. The graphical user interface is also configured to label each detection zone. For example, in FIG. 15, a water station is in detection zone 4 (“water station zone”), a feed station is in detection zone 8 (“feed station zone”) and a nest is in detection zone 5 (“nest zone”). Each of the data packets created may be stamped with the date and time, to the millisecond. The software application is configured so that the antenna zones are associated with specific spatial locations within the data store 81.

Generally, the data store 81 may accumulate many millions of data packets that record which animal RFID tag was in which detection zone. An example of the data packet sent to the server 80 is as follows:

| | Rack | Data | Reader | Antenna | Antenna | Enclosure | | | |
|---|---|---|---|---|---|---|---|---|---|
| Rack ID | shelf ID | hub ID | ID | ID | zone ID | ID | rodent ID | date | time |
| 1 | 1 | 1 | 1 | 1-0 | 1-0-1 | 1 | 9082408304 | 2016 Dec. 31 | 18:06:27 |

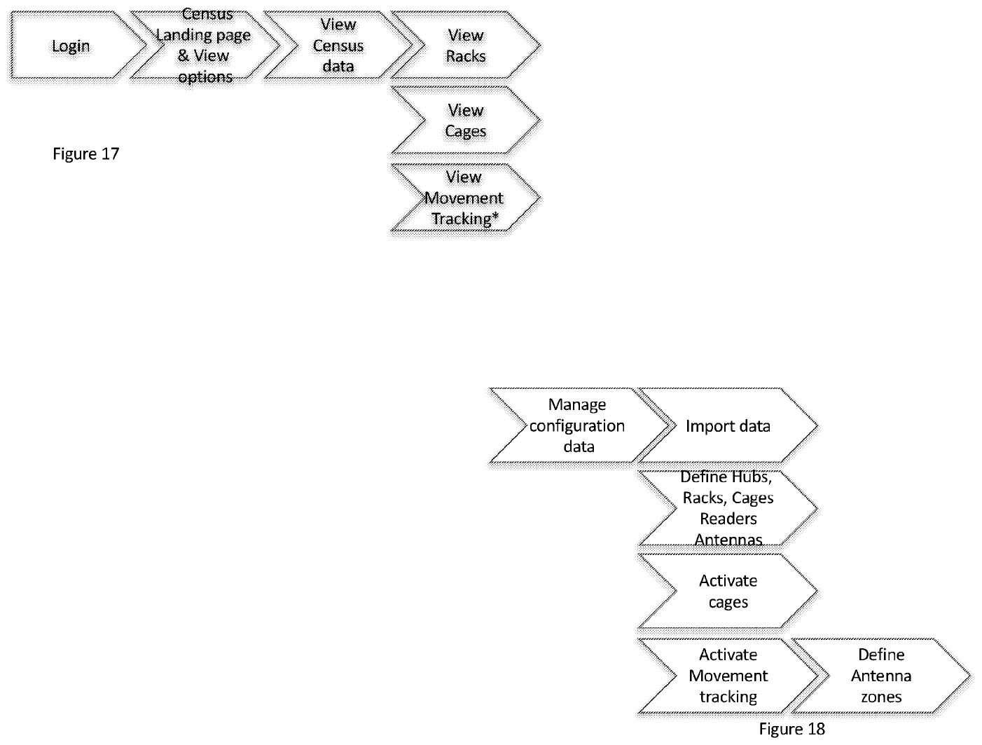

The information collection application can represent the data accumulated for any animal enclosure over a given period in generally any suitable way for a user. FIG. 15 shows a screen shot of an example representation of data accumulated for an animal enclosure, where each display object in the form of a circle represents a detection zone, and the shade of each circle is indicative of the time spent in each detection zone. A number representing the time spent by the animal in each detection zone may be in each circle, for example. Alternatively or additionally, the size of each circle may represent a percentage of time in the corresponding detection zone. FIG. 16 shows a screen shot of an example of another representation of data accumulated for an animal enclosure, where a line indicates the movement of the animal between the detection zones. The lines may indicate the movement of the animal in a period, which may be a user selected period. Alternatively or additionally, a time series of the movement may be displayed to the user. The detection zone in which an animal is located at a time may be indicated by highlighting the corresponding display object, for example by changing a visual property of the display object (e.g. changing shade and/or line thickness, adding or subtracting a box or mark). FIGS. 17 and 18 show example user navigation options in the information collection application and configuration application respectively.

In one embodiment of the invention, where animals are tagged with implanted RFID tags, their movement through a maze can be traced and recorded by placing the pad 60 beneath the maze pattern and sending the tag location data to the computing system 80 to determine the movement pattern and/or speed information.

In this but not all embodiments, the RFID tag 14 has dimensions of no more than 4 mm long×0.6 mm wide and a thickness of less than 0.6 mm. The RFID tag 14 is passive and comprises a semi-conductor integrated circuit (“RFID tag chip”), however it may take any suitable form. The RFID tag 15 has read/write capabilities and a memory to store data. Generally, the RFID tag may operate at any suitable frequency. In the present embodiment, the RFID tag 14 operates in the Ultra High Frequency (UHF) band (for example, in the range of 860 MHz to 920 MHz), configured to work within the regulated power maximum of 4 watts EIRP. The read distance of the tag 14 may be at least 70 mm. The RFID tag 14 is encapsulated in a bio-inert material in the form of glass, parylene or generally any suitable bio-inert material. An external dipole antenna may be either composed of or coated in a bio-inert highly electrically conductive material or composed of a highly electrically conductive material and coated in a bio-inert material that does not impede electrical conductance. The highly electrically conductive material coating an antenna may be made of a conductive metal, for example copper or silver, or another conductor examples of which include but are not limited to graphite powder or graphene.

Alternatively, the RFID tag 14 may comprise a Surface Acoustic Wave (SAW) tag operating at the 2.45 GHz ISM band, which requires low-level radio frequency (RF) pulses of about 10 mW, encapsulated in a bio-inert material, with dimensions of no more than 4 mm in length×0.6 mm in width and 0.6 mm thick connected to an antenna via its connector pads, with an external antenna either composed of or coated in a bio-inert highly electrically conductive material or composed of a highly electrically conductive material and coated in a bio-inert material that does not impede electrical conductance. Generally any suitable RFID tag may be used.

The RFID tag 14 may be implanted in the animal 12 as follows. A dermal incision is made. The dermal incision may be a dermal tail incision, however the RFID tag 14 may be attached to any suitable part of the animal 12. Optionally, bio-inert and sterile mineral oil may be applied to the skin surface to lubricate the skin to facilitate the piercing procedure. The incision may be made, for example, by forcing a skin-piercing tool into the dermis. The skin-piercing tool may in the form of, for example, a trocar, or a sharp blade or generally any suitable tool. In another step, a cannula is inserted into the dermal incision. The cannula may be inserted into the skin or subcutaneously for a distance of, for example, 5 mm. The RFID tag 14 is communicated through the cannula and out of a distal opening thereof. In another step, the cannula is withdrawn from the dermal incision.

Now that embodiments have been described, it will be appreciated that some embodiments have some of the following advantages:
An animal can be electronically identified, which may increase the rate of automatic identification and reduce the rate of false identification, and increase the rate of machine processing of animals, for example auto dosing of different animals that may require different doses of a substance.
More experimental data of higher quality may be obtained, which may improve research outcomes.
Surveys and counts may be performed in all enclosure phases, for example dark or night phases.
The location of an animal within an enclosure may be determined.
A change in behaviour indicative of a health issue may be determined and a veterinarian notified, thereby bringing forward care which may improve animal welfare and reduce the spread of infectious diseases to other animals within an enclosure, for example. Preventing an animal becoming ill or dying may prevent compromise of an experiment which may save time and/or expense.
The distribution of a plurality of animals between a plurality of enclosures, for example as found at a research facility, may be determined, and the location of each of the plurality of animals in their respective enclosures determined.
A time sequence of animal location information can be generated, the time sequence being indicative of the animal's movement.
Animal condition, including health, may be automatically determined.
A census of animals may be automated.
Animal movement can be determined without laborious manual observation.
Embodiments comprising a pad may be versatile, being placed under an enclosure in one use case, and may directly receive a mouse in another use case, for example.
A water spill may be detected.
An animal research facility may be run more efficiently in view of the automation of determination of identification and location.

Variations and/or modifications may be made to the embodiments described without departing from the spirit or ambit of the invention. For example, the radio frequency connectors may be SMA, SMB, type N, or generally any suitable connectors. The network connectors may be RJ45, BNC, USB, FIREWIRE, THUNDERBOLT or generally any suitable type of connectors. The networks may generally be any suitable network as appropriate, including but not limited to IEEE 802.3 and variants thereof, IEEE 802.11 and variants thereof, SONNET, SDH, ATM, DUST, ZIGBEE, FIBRECHANNEL, USB, BLUETOOTH, FIREWIRE, and THUNDERBOLT. The animal enclosures may take any suitable form, including but not limited to cages, pens, vivaria, terraria, tanks, shipping cartons, containers, and coops. The present embodiments are, therefore, to be considered in all respects as illustrative and not restrictive. Reference to a feature disclosed herein does not mean that all embodiments must include the feature.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1-71. (canceled)

72. A method for determining movement of an animal within an enclosure, the method comprising the steps of:
attaching a radio-frequency identification (RFID) tag to the animal;
disposing the animal within the enclosure which has a plurality of RFID tag detection zones associated therewith;
repeatedly interrogating the RFID tag which transmits a plurality of radio signals comprising animal identification information;
generating animal location information by determining which of the plurality of RFID tag detection zones are associated with the animal's location during transmission of each of the plurality of radio signals.

73. The method defined by claim 72 comprising the step of sending the animal identification information and the animal location information.

74. The method defined by claim 72 comprising the step of deriving the animal identification information from the plurality of radio signals.

75. The method defined by claim 72 comprising deriving behavior and/or condition of the animal from the animal location information so generated.

76. A system for determining movement of an animal within an enclosure, the system comprising:
interrogation means for repeatedly interrogating an RFID tag attached to the animal when disposed within an enclosure which has a plurality of RFID tag detection zones associated therewith and which transmits a plurality of radio signals comprising animal identification information;
animal location information generation means for determining which of the plurality of RFID tag detection zones are associated with the animal's location during transmission of each of the plurality of radio signals.
